(19) United States
(12) Patent Application Publication
(10) Pub. No.: US 2009/0106545 A1
(43) Pub. Date: Apr. 23, 2009

(54) BOOTING METHOD FOR COMPUTER SYSTEM

(75) Inventor: Chih-Sheng Chien, Taipei (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: ASUSTeK COMPUTER INC., Taipei (TW)

(21) Appl. No.: 12/254,803

(22) Filed: Oct. 20, 2008

(30) Foreign Application Priority Data
Oct. 23, 2007 (TW) 96139694

(51) Int. Cl. G06F 15/177

(52) U.S. Cl. 713/2

(57) ABSTRACT

A booting method for a computer system with a keyboard and a central processing unit (CPU). In the present method, the keyboard is initialized first. After that, the CPU is initialized in turn. Finally, other hardware devices of the computer system are initialized. The method modifies the order of the hardware initializations so as to determine whether to use system default values or BIOS setup values set by a user to do the initializations based on an input signal received by the keyboard before initializing the CPU. As a result, the situation of using the incorrect BIOS setup values for initializations, which leads to failure in booting the computer system, can be avoided.

### CROSS-REFERENCE TO RELATED APPLICATION

This application claims the priority benefit of Taiwan application serial no. 96139694, filed on Oct. 23, 2007. The entirety of the above-mentioned patent application is hereby incorporated by reference herein and made a part of specification.

### BACKGROUND OF THE INVENTION

1. Field of the Invention

The present invention relates to a method for booting a computer system and more particularly, to a method for booting a computer system in which the order of initializing hardware is changed.

2. Description of Related Art

In general, after a user presses the power button, a computer system goes through a series of hardware initializations, is checked for errors, and then may be normally booted. FIG. 1 is a flow chart of a conventional method for booting a computer system. Referring to FIG. 1, after the power of a computer system is turned on (step 110), a basic input/output system (BIOS) that is loaded into memory executes a power on self test (POST) to initialize and check the hardware components of the computer system and ensure normal operation of the hardware components.

First, as shown at step 120, a central processing unit (CPU) of the computer system is initialized to check if the flags and the status of the registers of the CPU are normal. Then, at step 130, a chipset is initialized to test the functions of the south bridge chip and the north bridge chip. Next, as shown at step 140, detection and related settings are performed on a memory. Finally, at step 150, initializations on peripheral devices such as the keyboard, mouse, 10 ports and sensors are performed. After all initializations on the hardware components are finished, at step 160, the booting process is executed according to the order specified by the user to boot the computer system from the floppy disk drive, the hard disk drive, or the CD drive and to load the operating system.

### SUMMARY OF THE INVENTION

In light of the above, the present invention provides a booting method in which the order of hardware initializations is changed to avoid the situation when the computer system fails to boot due to errors in BIOS setup values.

The present invention provides a booting method for a computer system comprising a keyboard and a CPU. The method includes the following steps. First, initialize the keyboard. Next, initialize the CPU. Finally, initialize other hardware devices of the computer system.

In one embodiment of the present invention, the step of initializing the keyboard comprises enabling a function of the keyboard to receive input signals, deciding whether to change a content of the Complementary Metal-Oxide Semiconductor (CMOS) memory of the computer system based on the input signal, and finally disabling the functions of the keyboard.

In one embodiment of the present invention, the step of initializing the hardware devices of the computer system comprises initializing a chipset of the computer system, detecting a memory of the computer system, and initializing peripheral devices of the computer system. The peripheral devices include at least a keyboard, peripheral component connected to the computer system through a serial port, a temperature sensor, or a fan speed sensor, etc.

In one embodiment of the present invention, after initializing other hardware devices of the computer system, an operating system is loaded into the computer system.

In another aspect, the present invention provides a booting method for a computer system. The method includes enabling an input interface, receiving an input signal through the input interface, and determining if the input signal is a specified signal. If the input signal is the specified signal, system default values of the computer system are used to initialize a CPU and hardware devices of the computer system.

In one embodiment of the present invention, the step after determining if the input signal is the specified signal further includes disabling the function of the input interface.

In one embodiment of the present invention, after determining whether the input signal is the specified signal, a content of the CMOS memory of the computer system is changed if the input signal is the specified signal. The CMOS memory is used to store the BIOS setup values set by the user. The step of changing the content of the CMOS memory includes changing the corresponding check sum value of the BIOS setup values.

In one embodiment of the present invention, after determining whether the input signal is the specified signal, BIOS setup values are used to initialize the CPU and hardware devices of the computer system if the input signal is not the specified signal. In other words, the BIOS setup values are used to initialize the CPU, the chipset, and the peripheral devices of the computer system and to detect the memory of the computer system.

In one embodiment of the present invention, the step of initializing the CPU and hardware devices based on the system default values includes first initializing the CPU based on the system default values and then initializing the chipset based on the system default values. Next, the memory is detected and the peripheral devices of the computer system are initialized based on the system default values.

In one embodiment of the present invention, the booting method further includes using the system default values to replace the BIOS setup values in the CMOS memory.

In one embodiment of the present invention, the step after initializing the CPU and hardware devices further includes loading an operating system.

In one embodiment of the present invention, the input interface includes a keyboard and the specified signal includes a key press event corresponding to a certain key.

In the present invention, before initializing the CPU of the computer system, part of the function of the keyboard is first enabled to detect if the certain key is pressed and accordingly decide if the system default values are required to be used to initialize the CPU and hardware devices. As such, the situation when the computer system fails to boot due to errors in the BIOS setup values may be avoided.

In order to make the aforementioned features and advantages of the present invention more comprehensible, several embodiments accompanied with figures are described in detail below.

### BRIEF DESCRIPTION OF THE DRAWINGS

FIG. 1 is a flow chart of a conventional method for booting a computer system.

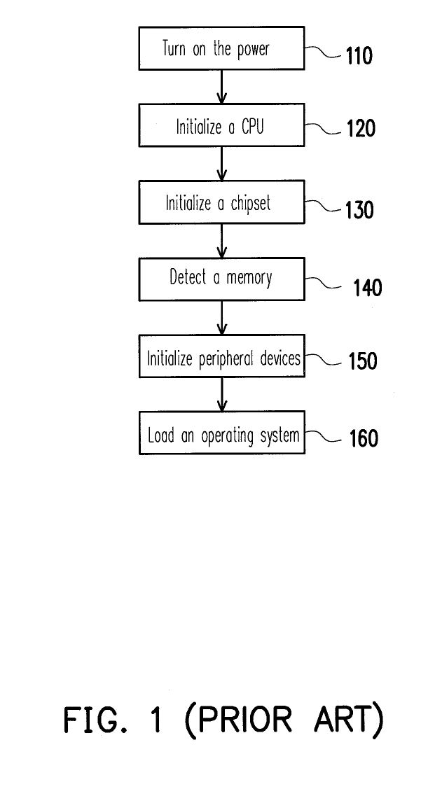

FIG. 2 is a flowchart of a booting method for a computer system according to one embodiment of the present invention.

FIG. 3 is a flowchart of a booting method for a computer system according to another embodiment of the present invention.

### DESCRIPTION OF EMBODIMENTS

The user may enter a BIOS setup menu and change BIOS setup values during a booting process of a computer system. The BIOS setup values are recorded in a Complementary Metal-Oxide Semiconductor (CMOS) memory of the computer system. However, if the user accidentally makes wrong settings (e.g. errors in setting the frequency or voltage of a CPU), the user may use a jumper on a motherboard to clear a content of the CMOS memory. Then, when rebooting the computer system, the BIOS will use system default values to initialize the hardware devices.

When performing the initialization of the computer system, the BIOS makes references to the BIOS setup values in the CMOS memory to set and check the hardware. If the initialization may automatically be based on the system default values when there are errors in the BIOS setup values, the situation when the computer system fails to boot due to errors in the BIOS setup values may be avoided. In view of the aforementioned, the present invention develops a booting method for the computer system. In order to make the present invention more comprehensible, embodiments are described below as the examples to prove that the invention can actually be implemented.

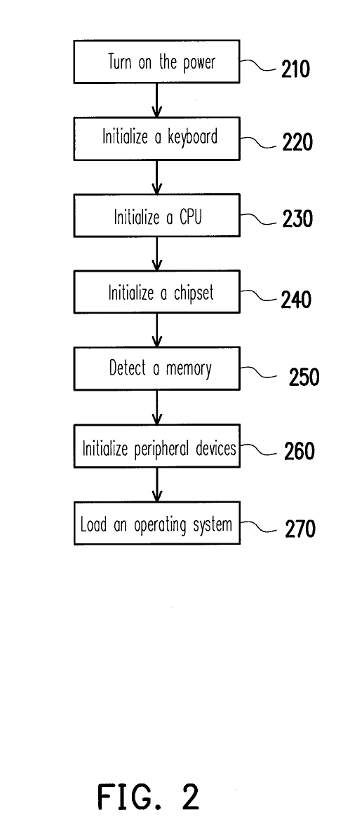

FIG. 2 is a flowchart of a booting method for a computer system according to one embodiment of the invention. Referring to FIG. 2, first, as shown in FIG. 210, when the user presses a power button to boot a computer system, a BIOS stored in the flash read only memory (ROM) is loaded into a memory to prepare to initialize and check hardware devices of the computer system.

At step 220, initialization is first performed on a keyboard that is connected to the computer system. More specifically, once the power of the computer system is turned on, a function of the keyboard that receives a key input is enabled to receive an input signal generated when the user presses a key. Upon receiving the input signal, a decision regarding whether to change (e.g. delete or modify) the content originally stored in the CMOS memory is made based on the type of the input signal. Finally, the function of the keyboard that receives the key input is disabled. That is, the keyboard can not receive or identify any input signal.

Next, in order to check the status of the hardware devices of the computer system and set correct parameters, the BIOS performs initializations on the CPU, the chipset, the memory, and the computer peripheral devices in sequence to ensure normal operations of the hardware devices after booting at steps 230 to 260. The peripheral devices include the keyboard, a mouse, all peripheral component s that are connected to the computer system through a serial port, a temperature sensor, or a fan speed sensor, etc. Thus, at step 260, a more complete initialization on the keyboard is performed again.

After the completion of all the abovementioned initializations, the hardware devices have passed the tests and will work normally. Finally, as shown at step 270, an operating system is loaded into the random access memory (RAM) to finish the booting process.

In the present embodiment, a decision regarding whether to change the content of the CMOS memory is made based on the input signal received by the keyboard before the BIOS performs initialization on the CPU. In modem computer architectures, the CMOS memory records several BIOS setup values such as the frequency of the CPU, speed of the memory, or voltage. The user may make changes to the setup values by entering in the BIOS menu according to habits or requirements. However, whether the BIOS setup values are correct directly affects if the computer system may be normally booted. Accordingly, the embodiment below illustrates the steps of how by changing the order of initializing the hardware devices, the computer system may be normally booted regardless of whether the BIOS setup values are correct.

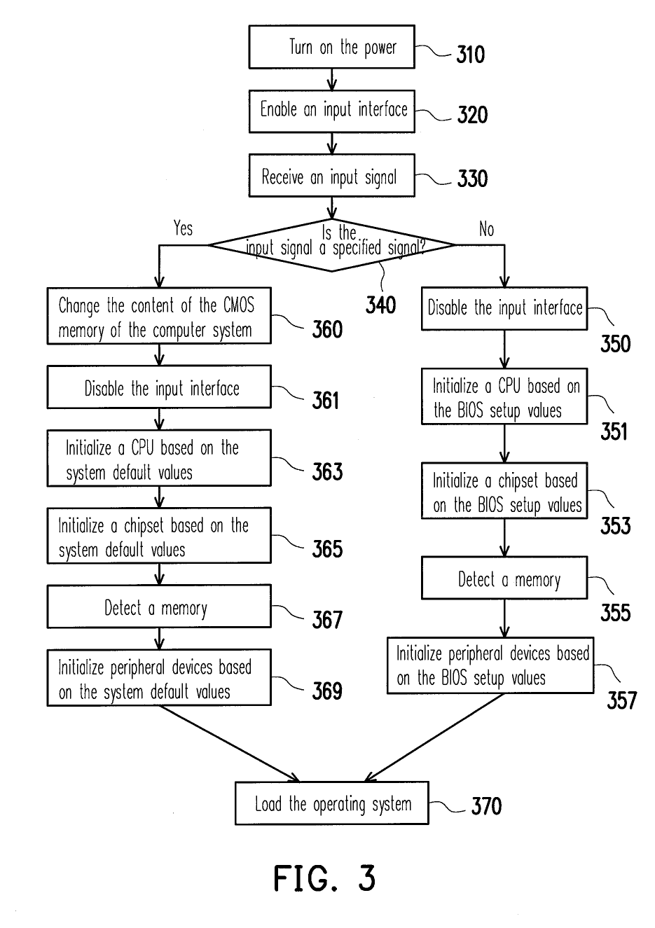

FIG. 3 is a flowchart of a booting method for a computer system according to another embodiment of the present invention. Referring to FIG. 3, first, as shown in step 310, the power of the computer system is turned on and a BIOS that is loaded in the memory is prepared to initialize the hardware.

At step 320, first, a basic function of the input interface is enabled. In the present embodiment, the input interface is a keyboard connected to the computer system, for example. The function of the keyboard that is enabled is a key input function, for example. That is, by enabling the function of the keyboard, a determination of whether any key is pressed and which key is pressed can be made.

Next, as shown at step 330, an input signal is received through the enabled input interface. In the present embodiment, the input signal may be a key press event generated by the user pressing down a key on the keyboard. As shown at step 340, after receiving the input signal, a determination about whether the input signal is a specified signal is made. The specified signal is, for example, a key press event corresponding to a certain key (e.g. the insert key). Through the above steps, a determination about whether the certain key is pressed by the user during the process of the booting the computer system can be made.

If the input signal is the specified signal (i.e. the user is pressing the certain key), the content of the CMOS memory of the computer system is changed as shown at step 360. In other words, the BIOS setup values set by the user are changed. In the present embodiment, the method of changing the BIOS setup values includes deleting or modifying the check sum value corresponding to the BIOS setup values.

Then, at step 361, to accurately perform the following initializations, the previously enabled function of the input interface is turned off. At this time, the keyboard will not react to any key input. Therefore, whether the user still presses down the key has no effect on the following initializations.

After the above steps, the BIOS performs initializations on the hardware devices of the computer system in sequence. First, as shown at step 363, the CPU is initialized. When initializing the CPU, relevant BIOS setup values have to be read from the CMOS memory. However, because the check sum value in the CMOS memory corresponding to the BIOS setup values has been changed, the CPU makes the determination that the BIOS setup values have an error and the BIOS will perform initializations based on the system default values (e.g. the factory default values of the CPU).

Similarly, at the following steps 365 to 369, because the check sum value has been changed to a value inconsistent with the BIOS setup values, the BIOS will also initialize and check the chipset, the memory, and the peripheral devices based on the system default values. When all the initializations on the hardware devices have been finished, the operating system is loaded into the memory to complete the booting process of the computer system as shown at step 370.

It should be mentioned that in the present embodiment, the system default values may be written back to the CMOS memory to replace the originally recorded BIOS setup values after the booting process of the computer system is completed. Compared with the conventional method in which the content of the CMOS is cleared through adjusting a jumper on the motherboard, the present embodiment provides a more convenient method of resetting the BIOS setup values.

Referring back to step 340, after determining whether the input signal is the specified signal, if the input signal is not the specified signal (i.e. the user does not press down the certain key), the previously enabled function of the input interface is turned off. Next, the BIOS initializes the hardware devices based on the BIOS setup values stored in the CMOS memory.

The initializations on the hardware devices are as shown at steps 351 to 357. First, when initializing the CPU, settings are based on the CPU frequency in the BIOS setup values and the registers and flags of the CPU are checked for accuracy (step 351). Next, the registers of the chipset are also set and checked based on the BIOS setup values (step 353). The memory is detected (step 355) and the peripheral devices of the computer system are initialized based on the BIOS setup values (step 357). In the present embodiment, the peripheral devices of the computer system may be a keyboard, a mouse, all peripheral components that are connected to the computer system through a serial port, a temperature sensor, a fan speed sensor, etc., which are not limited herein. Finally, as shown at step 370, after the initializations on the hardware devices are finished, the operating system is loaded to complete the booting process of the computer system.

Under a normal condition, the BIOS performs the initializations based on the BIOS setup values stored in the CMOS memory. In the present embodiment, even if the user enters a wrong value when modifying the BIOS setup values, which causes the computer system to fail to boot, the user only needs to keep pressing down the certain key on the keyboard and restart the computer system. The BIOS will check or set the hardware devices based on the system default values when performing initialization. The wrong BIOS setup values will be corrected as the system default values after the booting process is finished.

In summary, the booting method according to the above embodiment changes the initialization order of the hardware devices. Before reading from the CMOS memory to initialize the CPU, part of the keyboard function is enabled to detect user input. As long as the event of a user pressing down a certain key is detected, initializations on the CPU and other hardware devices are performed based on the system default values. As such, it does not matter if the user has caused any error when modifying the BIOS setup values. Through the above steps, the normal booting of the computer system can be ensured. The situation of the computer system failing to boot due to errors in the BIOS setup values may be avoided.

It will be apparent to those of ordinary skills in the technical field that various modifications and variations can be made to the structure of the present invention without departing from the scope or spirit of the invention. In view of the foregoing, it is intended that the present invention covers modifications and variations of this invention provided they fall within the scope of the following claims and their equivalents.

What is claimed is:

1. A booting method, used to boot a computer system comprising a keyboard and a central processing unit (CPU), the method comprising:
a. initializing the keyboard;
b. initializing the CPU; and
c. initializing hardware devices of the computer system.

2. The booting method according to claim 1, wherein step a comprises:
a1. enabling the keyboard to receive an input signal;
a2. determining whether to change a content of a Complementary Metal-Oxide Semiconductor (CMOS) memory of the computer system based on the input signal; and
a3. disabling the keyboard.

3. The booting method according to claim 1, wherein step c comprises:
c1. initializing a chipset of the computer system;
c2. detecting a memory of the computer system; and
c3. initializing at least one peripheral device of the computer system.

4. The booting method according to claim 3, wherein the peripheral devices comprise at least one of the keyboard, a peripheral component connected to the computer system through a serial port, a temperature sensor, and a fan speed sensor.

5. The booting method according to claim 1, wherein after step c, the method further comprises:
loading an operating system.

6. A booting method, used to boot a computer system, the method comprising:
d. enabling an input interface;
e. receiving an input signal through the input interface;
f. determining whether the input signal is a specified signal; and
g. initializing a CPU and hardware devices of the computer system based on system default values of the computer system if the input signal is the specified signal.

7. The booting method according to claim 6, wherein after step f, the method further comprises:
disabling the input interface.

8. The booting method according to claim 6, wherein after step f, the method further comprises:
changing a content of a CMOS memory of the computer system if the input signal is the specified signal, wherein the CMOS memory is used to store basic input/output system (BIOS) setup values set by the user.

9. The booting method according to claim 8, wherein the step of changing the content of the CMOS memory comprises:
modifying a check sum value corresponding to the BIOS setup values.

10. The booting method according to claim 8, wherein after step f, the method further comprises:
initializing the CPU and hardware devices based on the BIOS setup values if the input signal is not the specified signal.

11. The booting method according to claim 10, wherein the step of initializing the CPU and hardware devices based on the BIOS setup values comprises:
initializing the CPU based on the BIOS setup values;
initializing a chipset based on the BIOS setup values;
detecting a memory; and
initializing at least one peripheral device based on the BIOS setup values.

12. The booting method according to claim 6, wherein the step of initializing the CPU and hardware devices based on the system default values comprises:
initializing the CPU based on the system default values;
initializing a chipset based on the system default value;
detecting a memory; and
initializing at least one peripheral device based on the system default value.

13. The booting method according to claim 6, further comprising:
replacing the BIOS setup values in the CMOS memory with the system default values.

14. The booting method according to claim 6, wherein after step g, the method further comprises:
loading an operating system.

15. The booting method according to claim 6, wherein the input interface comprises a keyboard.

16. The booting method according to claim 6, wherein the specified signal comprises a key press event corresponding to a certain key.
